(19) United States
(12) Patent Application Publication
(10) Pub. No.: US 2004/0241592 A1
(43) Pub. Date: Dec. 2, 2004

(54) Method of manufacturing micro-structure and method of manufacturing micro-element

(75) Inventors: Ryo Kuroda, Kanagawa (JP); Tomohiro Yamada, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/851,105

(22) Filed: May 24, 2004

(30) Foreign Application Priority Data
May 27, 2003 (JP) 2003-148641

(51) Int. Cl. G03C 5/00

(52) U.S. Cl. 430/322

(57) ABSTRACT

A micro-structure is manufactured by a step of irradiating light onto a member having a modulation profile smaller than the wavelength of irradiated light and forming a distribution of optical near-field corresponding to said modulation profile on the surface of said member, a step of introducing material gas to be used for a photochemical reaction into a space containing said member and a step of causing said material gas to give rise to a photochemical reaction by means of optical near-field and forming a micro-structure on the surface of said member.

### BACKGROUND OF THE INVENTION

1. Field of the Invention

This invention relates to a method of manufacturing a micro-structure and a method of manufacturing a micro-element. More particularly, it relates to a method of manufacturing a micro-element that can suitably be used for a semiconductor device or an optical communication device.

2. Related Background Art

As a result of the technological development in recent years in the field of semiconductor memories toward larger capacities and also in the field of CPU toward higher processing speed and higher degree of integration, photolithography is inevitably required to adapt itself for further micronization. Generally, the limit of micro-processing of photolithography devices is about the wavelength of light. Therefore, the use of light having a shorter wavelength is encouraged for photolithography devices and currently near ultraviolet laser beams are used to make micro-processing of about 0.1 μm technically feasible.

Micro-processing devices using an optical near-field have been proposed as means that allow collective micro-processing of 0.1 μm or less.

For example, U.S. Pat. No. 6,171,730 proposes a near-field mask exposure technique of irradiating light onto the rear surface of an optical mask made of light-shielding film and having a pattern of apertures of 0.1 μm or less and collectively transferring the pattern of the optical mask onto photoresist by using optical near-field seeping out from the aperture pattern. The method and the apparatus disclosed in the above cited patent document are very excellent and have contributed greatly to the technological field to which the present invention relates.

However, the above-described micro-processing technique requires the use of a photolithography process that comprises steps of application of photoresist, exposure, development and etching to make the micro-processing a complex one because it involves the use of photoresist.

### SUMMARY OF THE INVENTION

Therefore, it is the object of the present invention to provide a method that makes it possible to process and manufacture a micro-structure by way of a simple process that does not require the use of a complex process such as photolithography.

In an aspect of the present invention, the above object is achieved by providing a method of manufacturing a micro-structure comprising: a step of irradiating light onto a member having a modulation profile smaller than the wavelength of irradiated light and forming a distribution of optical near-field corresponding to said modulation profile on the surface of said member; a step of introducing material gas to be used for a photochemical reaction into a space containing said member; and a step of causing said material gas to give rise to a photochemical reaction by means of optical near-field and forming a micro-structure on the surface of said member.

For the purpose of the invention, preferably, said step of forming a micro-structure includes the use of photochemical vapor deposition, photochemical etching or photochemical doping.

For the purpose of the invention, preferably, the profile of the distribution of optical near-field formed on the surface of said member is modified by changing the incident angle of light striking said member.

For the purpose of the invention, preferably, said member has micro-undulations on a substrate or made of light-shielding film having micro-apertures.

In another aspect of the invention, there is provided a method of manufacturing a micro-element by using a method of manufacturing a micro-structure according to the invention.

For the purpose of the invention, preferably, an element containing at least one of a quantum wire, a quantum dot and/or a single-electron transistor is manufactured as micro-element.

Alternatively, a second harmonic generating device or a sensor device may be manufactured as micro-element.

For the purpose of the invention, a method of manufacturing a micro-structure includes a method of processing a micro-structure.

According to the invention, it is possible to process and manufacture a micro-structure of a size of 0.1 μm or less by way of a simple process that does not require the use of a complex process such as photolithography.

### BRIEF DESCRIPTION OF THE DRAWINGS

FIGS. 1A and 1B are schematic illustrations of the micro-processing method used in Example 1;

FIGS. 2A and 2B are schematic illustrations of the micro-processing method used in Example 2;

FIG. 3 is a schematic illustration of the method of processing a quantum wire structure used in Example 3; and

FIG. 4 is a schematic illustration of the second harmonic generating device prepared in Example 4 by using the micro-processing method of Example 2.

### DESCRIPTION OF THE PREFERRED EMBODIMENTS

A method of manufacturing a micro-structure according to the invention includes a method of processing a micro-structure. Therefore, whenever necessary, the expression of a processing method will be used in the following description of the present invention.

A method of processing a micro-structure according to the invention comprises a step of causing light to strike a mold structure having a modulation profile smaller than the wavelength of irradiated light and forming a distribution of optical near-field corresponding to said modulation profile on the surface of said mold structure and a step of filling a space surrounding said formed distribution of optical near-field of said mold structure with material gas to cause a photochemical reaction to take place and forming a micro-structure on the surface of the mold structure by the photochemical reaction. In the step of forming a micro-structure by the photochemical reaction, said micro-structure may be formed by photochemical vapor deposition, photochemical etching or photochemical doping, using said photochemical reaction.

In the step of forming a distribution of optical near-field of a method of processing a micro-structure according to the invention, the profile of the distribution of optical near-field formed on the surface of said mold structure can be modified by changing the incident angle of light striking said mold structure.

For the purpose of the invention, a method of preparing a micro-element can be provided by using a method of processing a micro-structure as defined above to form a micro-structure from an element material on the surface of said mold structure by means of a photochemical reaction. When preparing a micro-element, said mold structure may be formed by using a mold structure having micro-undulations formed on a substrate and depositing the element material on the surface of the undulations by photochemical vapor deposition produced by a photochemical reaction so as to prepare a quantum wire structure, a quantum dot or a single-electron transistor structure. Alternatively, it is possible to form a mold structure by using a mold structure having micro-apertures in a light-shielding film and depositing the element material in the micro-apertures by photochemical vapor deposition produced by a photochemical reaction so as to prepare a second harmonic generating device or a sensor device.

A micro-element according to the invention is a micro-element comprising a mold structure and a micro-structure formed on the mold structure and characterized in that said micro-structure is formed by decomposing material gas by means of energy of optical near-field generated as a result of irradiation of light onto a mold structure having a modulation profile smaller than the wavelength of irradiated light.

For the purpose of the invention, a micro-structure can be formed by photochemical vapor deposition caused by decomposition of material gas, photochemical etching or photochemical doping.

The detailed characteristics of the present invention will become apparent from the following description.

### EXAMPLE 1

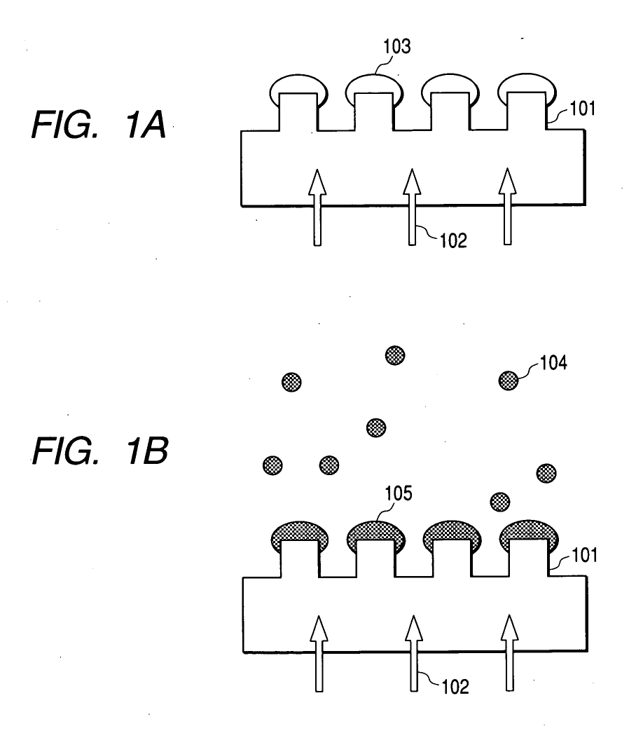

FIGS. 1A and 1B are schematic illustrations of the micro-processing method used in Example 1.

Referring to FIG. 1A, as incident light 102 is irradiated onto a mold structure 101 of a size smaller than the wavelength of light, an optical near-field distribution 103 that corresponds to the profile of the mold structure is formed on the surface of the mold structure 101.

As molecules of material gas 104 that can give rise to photochemical vapor deposition (photo CVD), photochemical etching and/or photochemical doping relative to light having a wavelength same as that of incident light 102 are filled in a space surrounding the mold structure 101, molecules of material gas 104 contact the optical near-field distribution 103 to give rise to deposition, etching and/or doping after dissociation and form a micro-structure 105 of the photochemical reaction product.

When a micro-structure is formed by photochemical vapor deposition that takes place as a result of a photochemical reaction in this example, it is possible to deposit a metal, a semiconductor or a dielectric material on a mold structure and form a micro-pattern by using gas of a metal compound as material gas and producing a metal, a semiconductor or a dielectric material by decomposing the material gas by means of energy of incident light.

Materials that can be used for material gas for the above-defined method include hydrides, halides and organic compounds of the target product which may be a metal, a semiconductor or a dielectric material. Examples of material gas include but not limited to AuCl, DMAu (dimethylgold), Cr(CO)₆, Cr(CO₂), Mo(CO)₆, W(CO)₆, WF₆, Al(CH₃)₃, Al₂(CH₃)₆, Al₂(iso-C₄H₉)₃, Zn(CH₃)₂, DMCd (dimethylcadmium), TiCl₄, Al₂(CH₃)₆, CuHF, Si₂H₆, Si₂H₆+Si(CH₃)H₃, SiH₄+CO₂, Si₂H₆+GeH₄, TiCl₄+O₂, Si₂H₆+O₂, Si₂H₆+NH₃, TaCl₅+O₂+O₃ and Al(CH₃)₃+N₂O. Any compounds that can be decomposed by energy of light can be appropriately used for the purpose of the invention.

When a micro-structure is formed by photochemical doping that takes place as a result of a photochemical reaction in this example, gas that is decomposed by energy of incident light to produce doping gas is used as material gas. Then, the surface of a mold structure that is typically made of silicon is doped with the impurity to form an electrically conductive layer and hence a micro-pattern on the surface of the mold structure.

Materials that can be used for material gas for the above-defined method include compounds of phosphorous or boron. Examples of material gas that can be used for the above process include but not limited to BCl₃, B₂H₆, B₅H₉, BF₃, B₁₀H₁₄, BBr₃, B(CH₃)₃, PH₃, PF₃, PF₅, PCl₃, PCl₅, POCl₃, and C₄H₁₁P. Any doping gases including those of arsenic type and gallium type that can be decomposed by energy of light can be appropriately used for the purpose of the invention.

Similarly, when a micro-structure is formed by photochemical etching that takes place as a result of a photochemical reaction in this example, gas that is decomposed by energy of incident light to produce etching gas is used as material gas. Then, the unnecessary parts of the surface of a mold structure can be removed to produce a micro-pattern. Materials that can be used for material gas for the above-defined method is various depending on the material used in the part subjected to etching. The gas may be used alone, or may be appropriately combined with other gases.

Light having a wavelength that is suitable for giving rise to a photochemical reaction such as gas decomposition, migration of active species or surface reaction relative to the material gas can be used as incident light. Even visible light or near infrared rays can give rise to a photochemical reaction when the phenomenon that is specific to optical near-field and discovered recently as described in Document 1: T. Kawazoe et al., Appl. Phys. Lett., Vol. 79, p. 1184 (2001) and Document 2: T. Kawazoe et al., Phys. Rev. Lett., Vol. 88, p. 0674 04-1 (2002) (excitation to a higher oscillation level in the bottom levels attributable to localization of optical near-field or direct transition to the dissociation major energy level) is used. Then, the scope of applicable light sources is broadened and a safe and low cost light source can be selectively used.

Some of the propagated component of incident light can leak to give rise to a photochemical reaction not only on the surface of the mold structure 101 but also in a space separated from the surface with the arrangement of FIGS. 1A and 1B. If such a leak is a problem, it can be avoided by adjusting the intensity of incident light in such a way that the practical threshold value for the rate of progress of the photochemical reaction is found between the intensity of optical near-field that is high and the intensity of propagated light that is relatively low on and near the surface.

While incident light 102 is irradiated onto the mold structure 101 from the rear surface side thereof in FIGS. 1A and 1B, it may alternatively be irradiated onto the mold structure 101 from the front surface side thereof and incident light may be irradiated onto the surface perpendicularly or inclined by a predetermined angle relative to the surface. The angle of incident light may be changed while the photochemical reaction with the material gas is in progress or incident light may be rotated around an axis. The change of the angle and/or the rotation of the incident light may be repeated regularly or irregularly. Alternatively, they may not be repeated at all. With the above described choice, it is possible to change the profile of the optical near-field distribution formed on the surface of the mold structure 101 so that micro-structures of the photochemical reaction product having different profiles can be obtained from a single mold structure.

### EXAMPLE 2

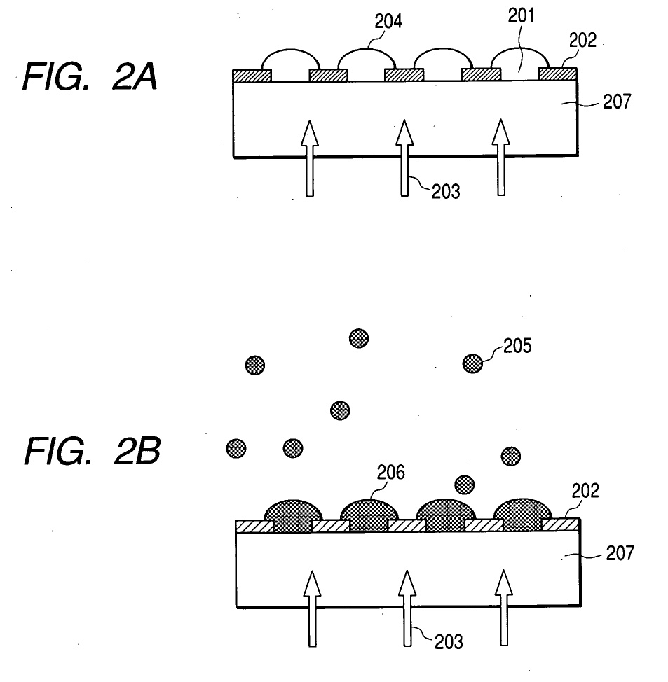

FIGS. 2A and 2B are schematic illustrations of the micro-processing method used in Example 2.

In FIGS. 2A and 2B, reference symbol 207 denotes a transparent substrate and reference symbol 202 denotes a light-shielding film arranged on the transparent substrate 207, while reference symbol 201 denotes a micro-aperture formed in the light-shielding film 202 with a size smaller than the wavelength of light.

As incident light 203 is irradiated onto the transparent substrate 207 from the rear surface side thereof, an optical near-field distribution 204 is formed at and near each of the micro-apertures 201 to correspond to the profile of the micro-aperture 201.

Then, as molecules of material gas 205, which give rise to photochemical vapor deposition (photo CVD) relative to light with the wavelength same as that of incident light 203, are made to fill a space surrounding each of the micro-apertures 201 in this condition, molecules of material gas 205 contact the optical near-field distribution 204 so that dissociation and deposition occur to form a micro-structure 206 of the deposited substance.

Otherwise, this example is same as Example 1.

### EXAMPLE 3

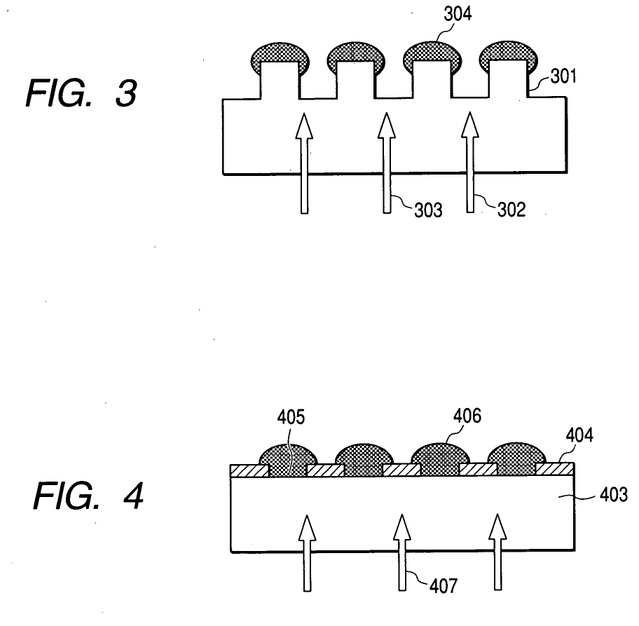

FIG. 3 is a schematic illustration of the method of processing a quantum wire structure used in

### EXAMPLE 3.

The processing method of this example is same as the micro-processing method of Example 1 and a quartz substrate that is processed by a semiconductor process to show micro-undulations or a plastic substrate that is processed by a nano-molding technique to show an undulation structure on the surface is used as mold structure described in Example 1.

Material gas that can decompose and deposit a metal or a semiconductor by way of a photochemical reaction that is made to occur by incident light is used.

Referring to FIG. 3, as incident light 302 is irradiated onto undulation structures 301, each. showing a structure of a size smaller than the wavelength of light, an optical near-field distribution is formed on the surface of each of the undulation structures 301 to correspond to its profile. Then, as molecules of the material gas are made to fill a space surrounding each of the undulation structures 301 in this condition, the metal or the semiconductor on the surface of the undulation structure 301 is decomposed to deposit as a result of a photochemical reaction so that quantum wire structures 304 are formed on the dielectric substrate 303.

With this technique, not only quantum wire structures but also quantum dots and single-electron transistor structures can be prepared in a similar manner.

### EXAMPLE 4

FIG. 4 is a schematic illustration of the second harmonic generating device prepared in Example 4 by using the micro-processing method of Example 2.

In this example, the micro-processing method of Example 2 is used and, after forming a metal thin film of Au or Ag on a glass substrate by using a semiconductor process just like the light-shielding film formed on the transparent substrate in Example 2, micro-slits/apertures with a width not greater than 100 nm are formed through the metal film.

Material gas that can deposit a nonlinear optical material by way of a photochemical reaction that is made to occur by incident light is used.

Then, incident light is irradiated onto the transparent substrate 403 from the rear surface side thereof and the material gas is made to fill a space surrounding each of the micro-slits/apertures 405 so as to deposit a filling of a nonlinear optical material in each of the micro-slit/apertures 405 as a result of a photochemical reaction as in Example 2. FIG. 4 shows the configuration of a second harmonic generating device prepared in this way, in which the micro-slits/aperture 405 formed through the metal thin film 404 on the transparent substrate 403 are filled with a nonlinear optical material 406.

Referring to FIG. 4, as light is irradiated onto the second harmonic generating device, the intensity of the electromagnetic field in each of the micro-slits/apertures is boosted by 10 to 1,000 times relative to incident light 407 so that it strongly interacts with the nonlinear optical material in the micro-slits/apertures. Therefore, it can consequently generate second harmonics of incident light 407 in an efficient way.

The micro-processing method of this example can also be used for depositing a sensor material so that, with the micro-processing method, it is possible to prepare not only a second harmonic generating device but also a sensor device adapted to detect the interaction between itself and the intensified electric field in the inside of the micro-slits/apertures.

What is claimed is:

1. A method of manufacturing a micro-structure comprising:
a step of irradiating light onto a member having a modulation profile smaller than the wavelength of irradiated light and forming a distribution of optical near-field corresponding to said modulation profile on the surface of said member;
a step of introducing material gas to be used for a photochemical reaction into a space containing said member; and
a step of causing said material gas to give rise to a photochemical reaction by means of optical near-field and forming a micro-structure on the surface of said member.

2. A method according to claim 1, wherein
photochemical vapor deposition is used in said. step of forming a micro-structure.

3. A method according to claim 1, wherein
photochemical etching is used in said step of forming a micro-structure.

4. A method according to claim 1, wherein
photochemical doping is used in said step of forming a micro-structure.

5. A method according to claim 1, wherein
the profile of the distribution of optical near-field formed on the surface of said member is modified by changing the incident angle of light striking said member.

6. A method according to claim 1, wherein
said member has micro-undulations on a substrate.

7. A method according to claim 1, wherein
said member is made of light-shielding film having micro-apertures.

8. A method of manufacturing a micro-element by using a method of manufacturing a micro-structure according to claim 1.

9. A method according to claim 8, wherein
an element containing at least one of a quantum wire, a quantum dot and/or a single-electron transistor is manufactured as micro-element.

10. A method according to claim 8, wherein
a second harmonic generating device or a sensor device is manufactured as micro-element.
